(19) United States
(12) Patent Application Publication
(10) Pub. No.: US 2003/0117272 A1
(43) Pub. Date: Jun. 26, 2003

(54) System and method of silent alarm

(76) Inventors: Robert E. Fegley, Rochester Hills, MI (US); Rajesh S. Chawla, Bloomfield Hills, MI (US); Robert Gilling, Caro, MI (US); Thomas A. Kenny, Troy, MI (US); Thomas Marquqrdt, Troy, MI (US); Carl Szasz, Rochester Hills, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/029,090

(22) Filed: Dec. 21, 2001

(51) Int. Cl. G08B 1/00

(52) U.S. Cl. 340/309.3; 368/12; 340/573.1; 340/407.1

(57) ABSTRACT

A system and method of providing a silent alarm is provided for tactilely alerting a user. The system includes a timekeeping device having a timekeeping mechanism for tracking real time, an input mechanism operatively connected to the timekeeping mechanism for setting an alarm time, a processor operatively connected to the timekeeping mechanism that monitors the real time and the alarm time, and a wireless data transmitter operatively connected to the processor, such that the wireless data transmitter transmits a signal at a predetermined radio frequency when the real time corresponds to the alarm time. The system also includes a silent alarm signaling device secured to a user, wherein said silent alarm signaling device includes a wireless data receiver, a processor operatively connected to the wireless data receiver, and a signaling mechanism operatively controlled by the processor. The method includes the steps of the user initializing the alarm time for the timekeeping device using the input mechanism, comparing the alarm time to the real time, activating a silent alarm if the alarm time corresponds to the real time by transmitting a predetermined radio frequency signal from the wireless data transmitter to the wireless data receiver, processing the signal using a microprocessor operatively connected to the wireless data receiver, and activating a signaling mechanism to provide the user a tactile alarm.

### BACKGROUND OF THE INVENTION

1. Field of the Invention

The present invention relates generally to alarm devices and, more specifically, to a system and method of providing an individual with a silent alarm.

2. Description of the Related Art

Alarm devices are well known in the art for alerting the occurrence of a particular event. For example, an alarm clock activates an audible alarm at the occurrence of the predetermined time programmed by a user. Certain types of audible alarm clocks include multiple alarm settings for activating the audible alarm at the occurrence of multiple times. While these audible alarm clocks work well, a disadvantage is that the sound level of the audible alarm is a disturbance to anyone within hearing distance.

Another type of an alarm device activates an inaudible alarm, such as a vibrating alarm, at a predetermined time. For example, a wristwatch with a vibrating alarm feature induces the wristwatch to vibrate at a predetermined time, to tactilely alert the user of the occurrence of a predetermined time. Another example of a silent alarm is a portable alarm clock that vibrates at the predetermined time to alert the user. This vibrating alarm clock is placed under the pillow of the user to awaken the user without disturbing anyone else. An advantage of the inaudible alarm is that the alarm signal is provided only to the actual user of the alarm. Another advantage of the inaudible alarm is that it provides a tactile signal to a user unable to hear an audible alarm. However, a disadvantage of the prior art inaudible alarm clock is that it is uncomfortable for the user to sleep on top of the alarm clock. Another disadvantage is that either the user or the alarm clock can shift positions while the user is asleep, resulting in the alarm clock out of position to alert the user.

Thus, there is a need in the art for a silent alarm device that provides a tactile signal to a user at a predetermined time, that is impervious to others.

### SUMMARY OF THE INVENTION

Accordingly, the present invention is a system and method of providing a silent alarm. The system includes a timekeeping device having a timekeeping mechanism for tracking real time, an input mechanism operatively connected to the timekeeping mechanism for setting an alarm time, a processor operatively connected to the timekeeping mechanism that monitors the real time and the alarm time, and a wireless data transmitter operatively connected to the processor, such that the wireless data transmitter transmits a signal at a predetermined radio frequency when the real time corresponds to the alarm time. The system also includes a silent alarm signaling device secured to a user, wherein said silent alarm signaling device includes a wireless data receiver, a processor operatively connected to the wireless data receiver, and a signaling mechanism operatively controlled by the processor.

The method includes the steps of the user initializing the alarm time for the timekeeping device using the input mechanism, comparing the alarm time to the real time, activating a silent alarm if the alarm time corresponds to the real time by transmitting a predetermined radio frequency signal from the wireless data transmitter to the wireless data receiver, processing the signal using a microprocessor operatively connected to the wireless data receiver; and activating a signaling mechanism to provide the user a tactile alarm.

One advantage of the present invention is that a system and method of providing a silent alarm sends a tactile signal at a predetermined time to only the user and does not disturb the user at other times. Another advantage of the present invention is that the system includes both a remotely located timekeeping device and a silent alarm signaling device worn by the user. Still another advantage of the present invention is that the silent alarm signaling device tactilely responds to the radio frequency signal transmitted by the remotely located timekeeping device. A further advantage of the present invention is that the timekeeping device can be operatively part of an alarm clock, video recording device or the like. Still a further advantage of the present invention is that the timekeeping device can send a plurality of signals to a plurality of silent alarm signaling devices.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a schematic diagram of a system of providing a silent alarm, according to the present invention.

FIG. 2 is a block diagram of the timekeeping device and silent alarm signaling device for the system of FIG. 1, according to the present invention.

FIG. 3 is a block diagram of another embodiment of a system of providing a silent alarm, according to the present invention.

FIG. 4 is a flowchart illustrating a method of providing a silent alarm using the system of FIG. 1, according to the present invention.

### DESCRIPTION OF THE PREFERRED EMBODIMENT(S)

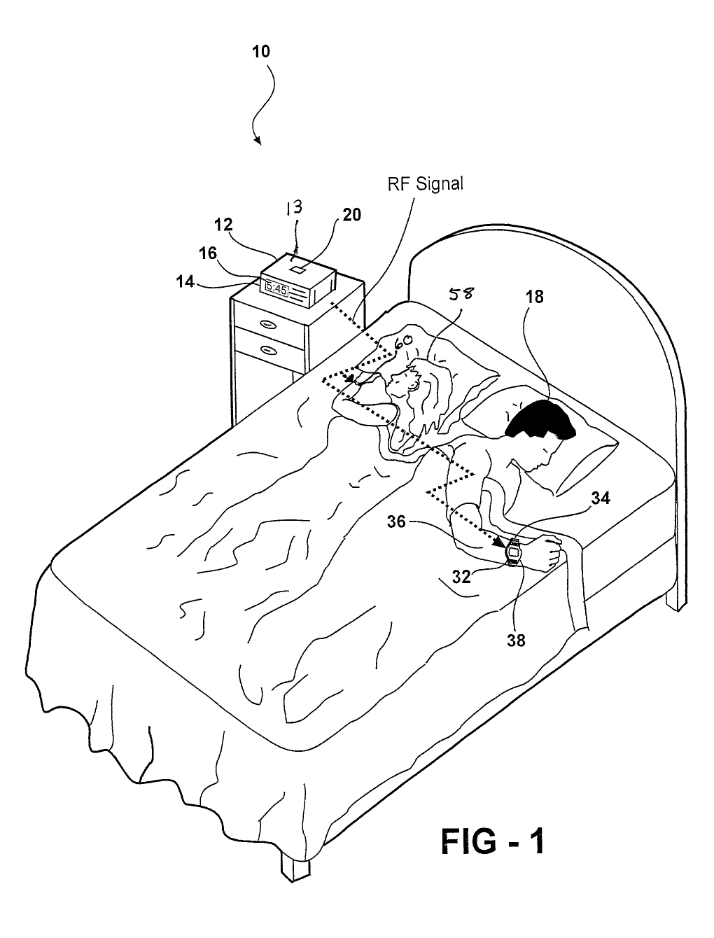

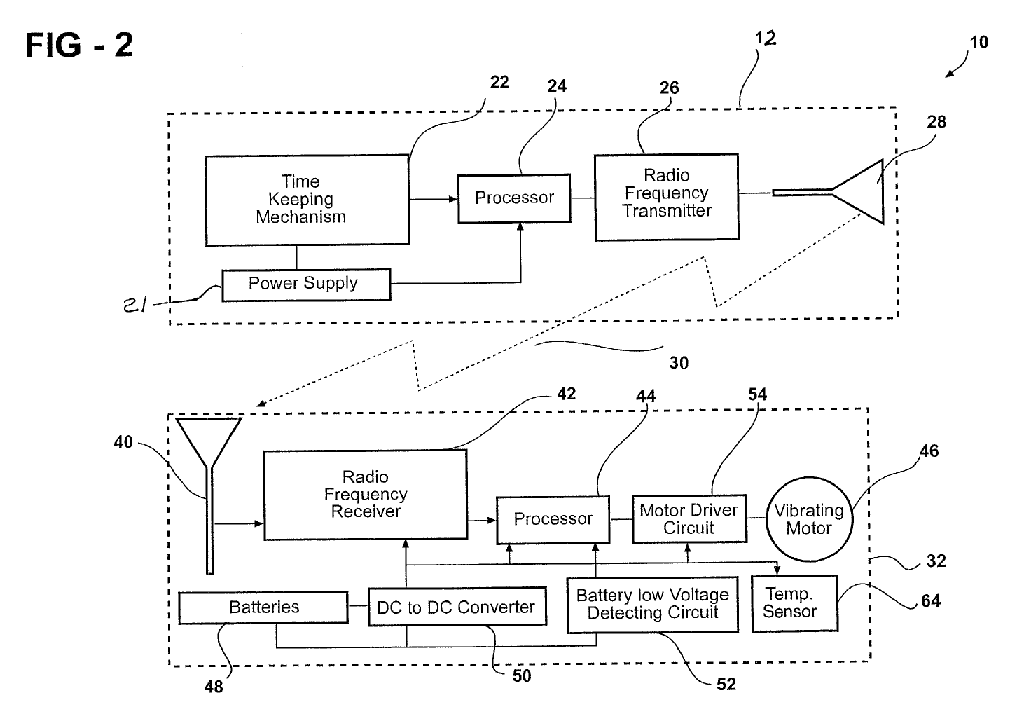

Referring to FIGS. 1 and 2, a system 10 of providing a silent alarm is illustrated. The system 10 includes a timekeeping device 12 that has an alarm mechanism for signaling a user 18 at the occurrence of a predetermined time. It is contemplated that the timekeeping device 12 can stand alone, or be incorporated in another device, such as a radio, or VCR, or DVD player or the like. In this embodiment, the timekeeping device 12 is a digital alarm clock 13. The timekeeping device 12 includes a housing 14 with a display 16 for displaying visual information, such as actual or real time, day or alarm setting or the like, to the user 18. The timekeeping device 12 also includes a user input mechanism 20, such as knobs, switches, keypad buttons or the like for use by the user 18 in operating the timekeeping device 12. As is known in the art, the timekeeping device 12 includes features such as time, day and alarm.

The timekeeping device 12 includes a timekeeping mechanism 22 disposed within the housing 14. The timekeeping mechanism 22 includes electrical circuits for operating the timekeeping device 12, such as crystals, capacitors, or resistors, or the like as is known in the art. The timekeeping mechanism 22 is operatively connected to the user input mechanism 20, which operatively transmits a signal representing the user's input to the timekeeping mechanism 22. The timekeeping device 12 also includes a power supply 21 disposed within the housing 14 for operating the clock 13 of this example, as is known in the art. The timekeeping device 12 further includes a processor 24 and a wireless data transmitter 26 that sends a signal 30. In this example the processor 24 is a logic circuit for processing information to operatively control the timekeeping mechanism 22. Also in this example, the wireless data transmitter is a radio frequency transmitter 26 having a transmitting antenna 28 that transmits a signal 30. The signal 30 is a radio frequency signal. The transmitting antenna 28 is a trace on a circuit board for the radio frequency transmitter 26. Preferably, the radio frequency transmitter 26 is an on-off keying OOK, SAW device controlled, Colpittz Oscillator transmitting at a predetermined frequency, such as 315 MHz. The signal 30 is transmitted a predetermined distance, such as 30 feet. The signal 30 contains information regarding the alarm, in a manner to be described.

The system 10 also includes a silent alarm signaling device 32 mounted to an attaching means 34. Various types of attaching means 34 are contemplated. One example of an attaching means 34 is an adjustable band made of a flexible material, such as cloth, leather, rubber or the like, for securing the silent alarm signaling device 32 around a limb 36 of the user 18. The attaching means 34 is secured around the limb 36, such as a wrist, forearm or leg of the user 18.

The silent alarm signaling device 32 includes a housing 38. Disposed within the housing 38 is a receiver antenna 40, operatively connected to a wireless data receiver 42, such as a radio frequency receiver. Preferably, the receiver antenna 40 is a trace on a circuit board and the receiver 42 is an amplitude modulated receiver, set to receive a corresponding signal from the radio frequency transmitter 26 in the timekeeping device 12, which in this example is at 315 MHz. It should be appreciated that in this example the radio frequency receiver 42 is periodically looking for a signal.

The silent alarm signaling device 32 includes a processor 44 for processing the signal received by the radio frequency receiver 42. The microprocessor includes logic circuits, with crystals, capacitors, resistors or the like to operatively process the signal from the radio frequency receiver 42 and activate a silent signaling device 46 disposed within the housing 38. Preferably, the processor 44 maintains an alarm identification system that associates a signal from a particular radio frequency transmitter 26 with one or more corresponding radio frequency receivers 42. For example, the signal includes a unique identifying code for use in associating the transmitter 26 and receiver 42. In this example, the system 10 initially learns the unique identifying code and retains the code until the battery 48 stops functioning. Advantageously, multiple users of the system 10 can establish their own alarm time, and receive a silent alarm when the real time corresponds to the alarm time they set.

The silent signaling device 46 sends a tactile signal to the user 18 when activated. An example of a signaling device 46 is a vibrating motor, such as an eccentric weight motor, that vibrates when operational. Preferably, the motor vibrates a predetermined rate for a predetermined time period. For example, the motor initially vibrates at a slow rate for a period of time, and then at a fast rate for a predetermined period of time.

In operation, the user 18 sets an alarm time using the input mechanism 20 for the timekeeping mechanism 22. When the time of day matches the alarm time, the radio frequency transmitter 26 sends out a signal 30. The radio frequency receiver 42 receives the signal 30, identifies the signal 30, and if appropriate activates the silent signaling device 46.

Advantageously, the silent signaling device 46 may include other features. For example, the silent signaling device 46 may be activated for a predetermined period of time when the alarm time is set, to enhance the user's confidence in the functionality of the system by letting them know an alarm is set. In addition, the silent signaling device 46 may provide the user 18 with a predetermined signal to indicate that the battery 48 is low, such as a unique vibration pattern for a predetermined period of time. Further, the user 18 may set multiple alarm times. Similarly, another user 58 of the system 10 with their own silent alarm signaling device 60, may set a desired alarm time and receive a unique signal 30 when the desired alarm time matches the actual time.

It should also be appreciated that the silent alarm signaling device 32 includes a power source 48, such as a battery, and other circuits known in the art, to operatively receive the signal, process the signal and activate the signaling device, such as a DC to DC converter 50 or battery low voltage detecting circuit 52, or motor driver circuit 54 or the like. It should also be appreciated that the silent alarm signaling device 32 may include a timekeeping mechanism and display (not shown), for also providing the user 12 with the timekeeping features of a watch.

In another embodiment of the system 10, the silent alarm signaling device 32 includes a power saving feature for the silent alarm signaling device. The system 10 includes a temperature sensor, as shown at 64 in FIG. 2. Preferably, the temperature sensor is a thermistor. The temperature sensor 64 senses temperature, and sends a signal to the processor 44. The processor 44 evaluates the signal to determine if the silent alarm signaling device 32 is being worn by a user 18, 58. For example, it compares the sensed temperature to a predetermined temperature, such as 95°. If the sensed temperature is greater than the predetermined temperature, the radio frequency receiver 42 is activated to search for a signal 30. If the sensed temperature is less than the predetermined temperature, the radio frequency receiver 42 is not activated to conserve power.

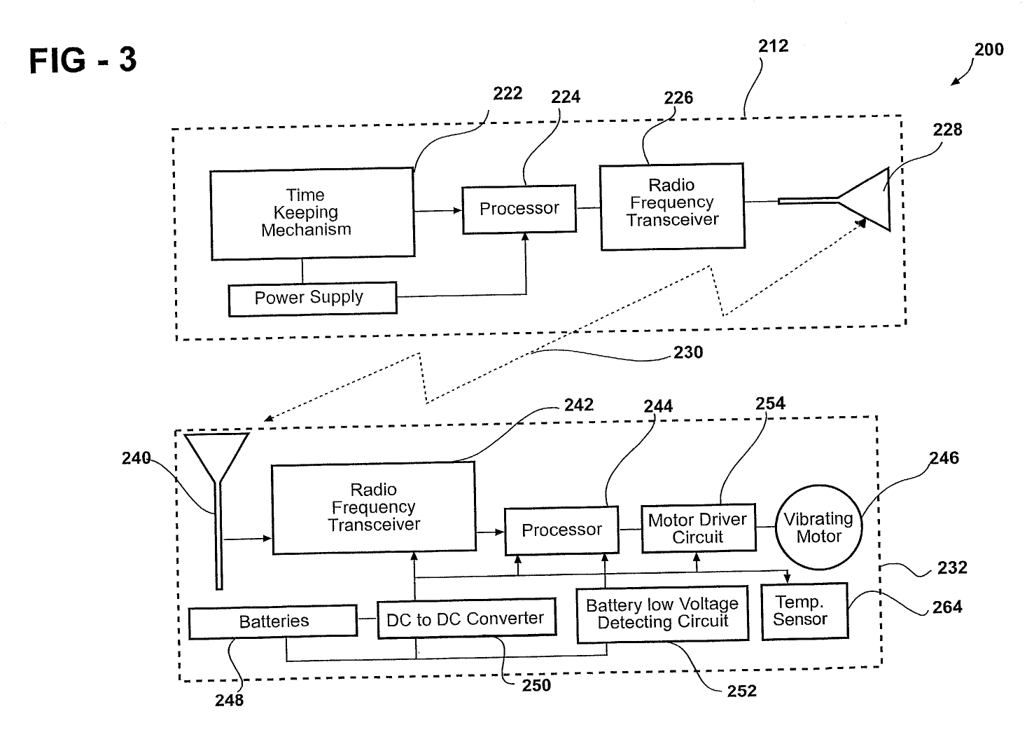

Referring to FIG. 3, in still another embodiment of the present invention, a silent alarm system 200 with two-way communication is illustrated. It should be appreciated that like components have like numeric indicators, increased by 200. Advantageously, the system 200 provides for two-way communication between the timekeeping device 212 and the silent alarm signaling device 232. The timekeeping device 212 includes a wireless data transceiver 226. In this example, the wireless data transceiver 226 is a radio frequency transceiver. Similarly, the silent alarm signaling device 232 includes a wireless data transceiver 242, that in this example is a radio frequency transceiver. The transceiver can both transmit and receive a signal. Therefore, the timekeeping device transceiver 226 transmits a signal 230 to the silent alarm signaling device transceiver 242, as previously described. In addition, the silent alarm signaling device transceiver 242 can send a signal 230 back to the timekeeping device transceiver. For example, the user 18 can send a signal to shut off the alarm.

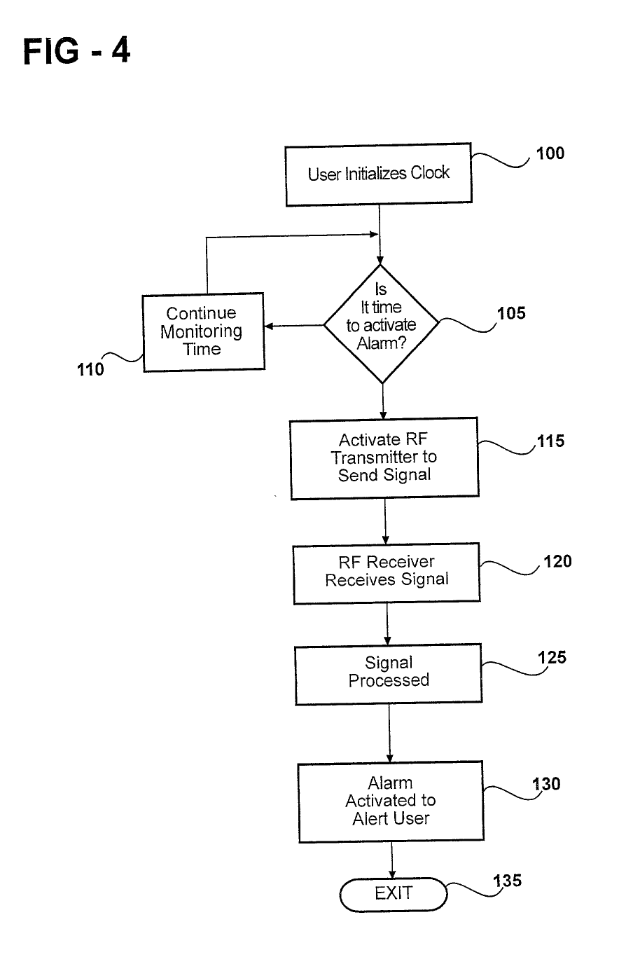

Referring to FIG. 4, the method of providing a silent alarm using the system of FIGS. 1-3 is illustrated. The method begins in block 100, and the user 18 initializes the alarm feature of the timekeeping device 12, which in this example is a clock 13. For example, the user 18 sets the time for the alarm to activate using the input mechanism 20. In this example, the user 18 sets one alarm time, although it is contemplated that multiple alarm times can be set and monitored by the system 10, as previously described. It is assumed that the user 18 has already set the clock 12 for the current time of day. Further, the user 18 may select to set a silent alarm, audible alarm or both types of alarm. In addition, the timekeeping device 12 initially learns the identification of the silent alarm signaling device 32. The timekeeping device 12 retains the identification until the battery 48 is changed, at which time reinitialization is preformed. The methodology advances to diamond 105.

In diamond 105 the methodology determines if it is time to activate the alarm. For example, the timekeeping mechanism 22 monitors the actual or real time of day, and compares the real time to the alarm time. If it is not time to turn the alarm on, the methodology advances to block 110 and continues to monitor the time. The methodology returns to block 105 and continues. Returning to diamond 105, if it is time to turn the alarm on, the methodology advances to block 115.

In block 115 a signal is sent to activate the alarm. For example, the microprocessor 24 in the clock 12 sends a signal to the radio frequency transmitter 26 to transmit an output signal 30 indicating that the alarm should be activated. In this example, the signal 30 is a radio frequency signal containing information regarding the alarm. Examples of information include an identification code for the silent alarm signaling device 32, the number of alarm messages to be sent, the alarm mode or the activation time. The methodology advances to diamond 120.

In block 120, the receiver antenna 40 of the silent alarm signaling device 32 receives the radio frequency signal 30 from the transmitter 26 in the clock 12. It should be appreciated that in this example the wireless data receiver 42 periodically looks for a signal. The methodology advances to block 125. In block 125, the microprocessor 44 processes the information contained in the signal 30 transmitted from the clock 12. For example, the processor 44 uses the identifying code to determine if the signal is for this particular silent signaling device 46. The methodology advances to block 130.

In block 130, the microprocessor activates the silent signaling device 46. In this example, the silent signaling device 46 is a vibrating motor which is powered on and begins to vibrate at a predetermined rate, as previously described. The vibrations of the motor are transmitted through the housing 38 of the silent alarm signaling device 32. The user 18 is alerted to the alarm by the vibrating movement of the silent signaling device 46. In this example, the vibration motor initially vibrates at a slow rate, and then at a fast rate, if not immediately acknowledged by the user 18. The methodology advances to bubble 135 and ends.

It should be appreciated that the silent alarm may include other features, such as a sleep timer, which the user 18 activates to reset the alarm to provide another alert to the user in a predetermined period of time. Another feature of the alarm is a user set vibration mode, such as a slow vibration mode or a fast vibration mode.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A system of providing a silent alarm comprising:
a timekeeping device having a timekeeping mechanism for tracking real time;
an input mechanism operatively connected to said timekeeping mechanism for setting an alarm time;
a processor operatively connected to said timekeeping mechanism that monitors the real time and the alarm time;
a wireless data transmitter operatively connected to said processor, wherein said wireless data transmitter transmits a signal at a predetermined radio frequency when the real time corresponds to the alarm time; and
a silent alarm signaling device secured to a user, wherein said silent alarm signaling device includes a wireless data receiver, a processor operatively connected to said wireless data receiver, and a signaling mechanism operatively controlled by said processor, such that the signal received by the wireless data receiver is processed by the processor, which activates the signaling mechanism to send the user a tactile signal.

2. A system as set forth in claim 1 wherein said timekeeping device includes a housing and said timekeeping mechanism is disposed within said housing.

3. A system as set forth in claim 1 wherein said wireless data transmitter is a radio frequency transmitter operatively connected to a transmitting antenna for transmitting a predetermined radio frequency signal.

4. A system as set forth in claim 3 wherein said wireless data receiver is a radio frequency receiver operatively connected to a receiving antenna for receiving a predetermined radio frequency signal from said corresponding radio frequency transmitter.

5. A system as set forth in claim 4 wherein said radio frequency receiver periodically looks for a signal from said corresponding radio frequency transmitter.

6. A system as set forth in claim 1 wherein said silent alarm signaling device is mounted to an attaching means that is secured to the user.

7. A system as set forth in claim 6 wherein said attaching means is a wristband.

8. A system as set forth in claim 1 wherein said signaling mechanism is a vibrating motor.

9. A system as set forth in claim 1 wherein said silent alarm signaling device includes a timekeeping mechanism and time display.

10. A system as set forth in claim 1 wherein at least one user sets a predetermined alarm time, and the silent alarm signaling device corresponding to the user is activated for each alarm time.

11. A system as set forth in claim 1 wherein the signal transmitted by the wireless data transmitter contains an identifying code, and the wireless data receiver contains an identifying code, and the processor activates the signaling mechanism to send the user a tactile signal if the wireless data transmitter identifying code matches the wireless data receiver identifying code.

12. A system of providing a silent alarm comprising:
a timekeeping device having a timekeeping mechanism for tracking real time;
an input mechanism operatively connected to said timekeeping mechanism for setting an alarm time;
a processor operatively connected to said timekeeping mechanism that compares the real time and the alarm time;
a wireless data transmitter operatively connected to said processor, wherein said wireless data transmitter is a radio frequency transmitter operatively connected to a transmitting antenna for transmitting a predetermined radio frequency signal when the real time corresponds to the alarm time;
a silent alarm signaling device secured to a user;
said silent alarm signaling device including a wireless data receiver, wherein said wireless data receiver is a radio frequency receiver operatively connected to a receiving antenna for receiving a predetermined radio frequency signal from said corresponding radio frequency transmitter;
a processor operatively connected to said wireless data receiver to process the predetermined radio frequency signal received by the radio frequency transmitter from the radio frequency receiver; and
a signaling mechanism operatively controlled by said processor to send the user a tactile signal.

13. A system as set forth in claim 12 wherein said timekeeping device includes a housing and said timekeeping mechanism is disposed within said housing.

14. A system as set forth in claim 12 wherein said radio frequency receiver periodically looks for a signal from said corresponding radio frequency transmitter.

15. A system as set forth in claim 12 wherein said silent alarm signaling device is mounted to an attaching means that is secured to the user.

16. A system as set forth in claim 15 wherein said attaching means is a wristband.

17. A system as set forth in claim 12 wherein said signaling mechanism is a vibrating motor.

18. A system as set forth in claim 12 wherein said silent alarm signal device includes a timekeeping mechanism and time display.

19. A system as set forth in claim 12 wherein at least one user sets a predetermined alarm time, and the silent alarm signaling device corresponding to the user is activated for each alarm time.

20. A system as set forth in claim 12 wherein the signal transmitted by the wireless data transmitter contains an identifying code, and the wireless data receiver contains an identifying code, and the processor activates the signaling mechanism to send the user a tactile signal if the wireless data transmitter identifying code matches the wireless data receiver identifying code.

21. A method of providing a silent alarm, said method comprising the steps of:
a user initializing an alarm time for a timekeeping device using an input mechanism;
determining if the alarm time corresponds to the real time;
activating a silent alarm if the alarm time corresponds to the real time by transmitting a predetermined radio frequency signal from a wireless data transmitter in the timekeeping device;
receiving the predetermined radio frequency signal from the wireless data transmitter by a wireless data receiver in a silent alarm signaling device secured to a user;
processing the signal using a microprocessor operatively connected to the wireless data receiver; and
activating a signaling mechanism to provide the user a tactile alarm.

22. A method as set forth in claim 21 wherein said timekeeping device includes a housing and said timekeeping mechanism is disposed within said housing.

23. A method as set forth in claim 21 including the step of the radio frequency receiver periodically looking for a signal from the corresponding radio frequency transmitter.

24. A method as set forth in claim 21 wherein the step of processing the signal using a microprocessor operatively connected to the wireless data receiver further comprises comparing an identifying code in the signal transmitted by the wireless data transmitter to an identifying code for the wireless data receiver, and activating the signaling mechanism to provide the user a tactile alarm if the wireless transmitter identifying code matches the wireless data receiver identifying code.

25. A system of providing a silent alarm comprising:
a timekeeping device having a timekeeping mechanism for tracking real time;
an input mechanism operatively connected to said timekeeping mechanism for setting an alarm time;
a processor operatively connected to said timekeeping mechanism that monitors the real time and the alarm time;
a wireless data transceiver operatively connected to said processor, wherein said wireless data transceiver transmits a signal at a predetermined radio frequency when the real time corresponds to the alarm time; and
a silent alarm signaling device secured to a user, wherein said silent alarm signaling device includes a wireless data transceiver, a processor operatively connected to said wireless data transceiver, and a signaling mechanism operatively controlled by said processor, such that the signal received by the wireless data transceiver is processed by the processor, which activates the signaling mechanism to send the user a tactile signal.

26. A system as set forth in claim 25, wherein said timekeeping device transceiver and said silent alarm signaling device transceiver are in two-way communication with each other.
